(19) United States
(12) Patent Application Publication
(10) Pub. No.: US 2008/0093156 A1
(43) Pub. Date: Apr. 24, 2008

(54) Modular steering gear housing

(76) Inventors: Jagadish K. Peringat, Rogersville, TN (US); Joe Brooks, Rogersville, TN (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/585,567

(22) Filed: Oct. 24, 2006

(51) Int. Cl. B62D 5/06

(52) U.S. Cl. 180/428

(57) ABSTRACT

A steering gear housing assembly includes a central housing member. A tower housing member includes a first plurality of mutually interconnected tubular sections secured to the central housing member. The tower end cap housing member includes at least one tubular section coupled to the central housing member. A rack housing member includes a second plurality of interconnected tubular sections secured to the central housing member. A rack end housing member includes a third plurality of interconnected tubular sections secured to the central housing member. An end cap retention housing member includes at least one tubular section secured to the central housing member.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of Invention

This invention relates in general to steering systems, and more specifically, to a steering gear housing.

2. Background of Related Art

Rack and pinion steering gear assemblies typically include a steering gear housing that houses a steering gear that is coupled to a rack. The rack is coupled to the tie rods and includes teeth that mesh with the steering gear for moving the rack laterally in either direction. The rack also includes a piston coupled about the exterior surface of the rack. Seals are disposed at each end of the rack for creating respective fluid chambers on each side of the piston. Pressure lines provide pressurized hydraulic fluid to and from each of the respective chambers. Pressurized hydraulic fluid is provided to and from each chamber for assisting the driver in moving the rack. As the steering system senses the drivers input on the steering wheel, hydraulic fluid is provided to a respective chamber for pressurizing the chamber and exerting a force on a respective side of the piston for assisting the driver in moving the rack.

Housings for hydraulic rack and pinion designs typically include one piece housings, two piece housings, or three piece housings. A one piece housing, typically made from aluminum, houses the entire gear. The two-piece housing typically includes two variants. A first variant includes an aluminum pinion valve housing attached to a steel tube. A second variant of the two piece housing design includes a separate pinion valve housing attached to an aluminum rack and tube housing. The three piece housing typically includes two variants. A first variant of the three piece housing includes a rack housing attached to an aluminum or steel tube with a valve housing. The second variant of the three piece housing includes a pinion valve housing attached to a rack tube and a separate rack bushing housing. Due to the numerous housings and variants for constructing a housing, including various housing lengths and different mounting locations for adapter fittings, specially designed housings, which require custom die cast parts and custom length tubes, are time consuming and expensive especially when the housings are specially made for low volume production.

### BRIEF SUMMARY OF THE INVENTION

The present invention has the advantage of utilizing standard tubular sections for assembling modular steering gear housing assemblies. Standardized tubular sections may be coupled to a central yoke portion to assembly a modular steering gear housing of a desired length. In addition, the standardized tubular sections of the modular steering gear housing, which include bores, may be circumferentially rotated prior to being interconnected for alignment and to a respective pressure line conduit. As a result, special manufactured housings, whether they are of an uncommon size or low volume, may be produced using standardized parts without increased cost or time to manufacture.

In one aspect of the present invention, a steering gear housing assembly includes a central housing member. A tower housing member includes a first plurality of mutually interconnected tubular sections secured to the central housing member. The tower end cap housing member includes at least one tubular section coupled to the central housing member. A rack housing member includes a second plurality of interconnected tubular sections secured to the central housing member. A rack end housing member includes a third plurality of interconnected tubular sections secured to the central housing member. An end cap retention housing member includes at least one tubular section secured to the central housing member.

In yet another aspect of the present invention, a steering gear assembly includes an input shaft having a gear formed on the input shaft. A rack tube is provided that includes teeth for meshing with the gear of the input shaft. A modular housing includes a central housing member having an interior housing portion for housing an interconnection between the gear of the input shaft and the teeth of the rack tube. The central housing member includes a first port and a second port with at least one port aligned with a first axis for providing access to the interior of the central housing member. The central housing member includes a third port and a fourth port with at least one port aligned with a second axis for providing access to the interior of the central housing member. The central housing further includes a fifth port aligned with a third axis for providing access to the interior of the central housing member. A tower housing member is axially aligned with the first axis for housing a first portion the input shaft. The tower housing member includes a first plurality of interconnected tubular sections secured to the central housing member at the first port. A tower end cap housing member is axially aligned with the first axis for housing a second portion of the input shaft. The tower end cap housing member includes at least one tubular section secured to the central housing member at the second port. A rack housing member is axially aligned with the second axis for housing a first portion of the rack tube. The rack housing member includes a second plurality of interconnected tubular sections secured to the central housing member at the third port. A rack end housing member is axially aligned with the second axis for housing a second portion of the rack tube. The rack end housing member includes a third plurality of interconnected tubular sections secured to the central housing member at the fourth port. An end cap retention housing member is axially aligned with the third axis including at least one tubular section. The end cap section is secured to the central housing member at the fifth port. A first rack seal and a second rack seal are disposed within the rack housing member with the first rack seal being in spaced relation to the second rack seal. A piston is coupled to the rack and is spaced between the first rack seal and the second rack seal. A first fluid chamber is formed within the rack housing member between the first rack seal and the piston. A second fluid chamber is formed within the rack housing member between the second rack seal and the piston. A first fluid conduit is coupled to a first respective tubular section of the tower housing member for transferring fluid between the first tower housing member and the first fluid chamber. A second fluid conduit is coupled to the first tubular section of the tower housing member for transferring fluid between the first tower housing member and the second fluid chamber.

A method for assembling modular steering gear housing includes providing a central housing member having a first port, a second port, a third port, a fourth port, and a fifth port. A first plurality of tubular sections is aligned with the first port of the central housing member. The first plurality of tubular sections includes a plurality of ring members. The plurality of ring members each have a respective bore through a respective wall section. The plurality of ring members are orientated circumferentially so that a respective bore of each ring member is aligned for coupling to a respective fluid conduit. A first plurality of tubular sections is interconnected for forming a tower housing member. The tower housing member is secured to the first port of the central housing member. A tower end cap is secured to the second port of the central housing member. The tower end cap includes at least one tubular section. A second plurality of tubular sections is interconnected to form a rack housing member. The rack housing member is secured to the third port of the central housing member. The third plurality of tubular sections is interconnected to form a rack end housing member. The rack end housing member is secured to the fourth port of the central housing member. An end cap retention housing member is secured to the fifth port of the central housing member.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a modular steering gear assembly according to a first preferred embodiment.

FIG. 2 is an exploded view of the modular housing of the steering gear assembly to a first preferred embodiment.

FIG. 3 is an assembly of a modular steering gear housing according to a first preferred embodiment.

FIGS. 4a-c illustrate methods of interconnecting various tubular sections.

FIGS. 5a-b are perspective view and a cross section view, respectively, of a rack intermediate flange member according to a first preferred embodiment of the present invention.

FIGS. 6a-b are a perspective view and a cross section view, respectively, of a rack intermediate flange member according to a second preferred embodiment of the present invention.

FIGS. 7a-b are perspective view and a cross section view, respectively, of a rack intermediate flange member according to a third preferred embodiment of the present invention.

### DETAILED DESCRIPTION OF THE PREFERRED EMBODIMENT

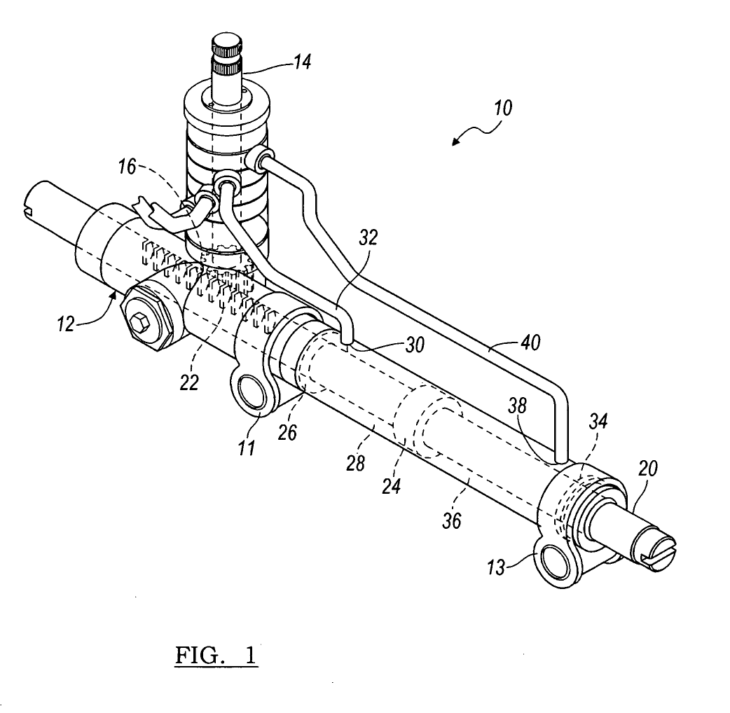

Referring now to the drawings, there is illustrated in FIG. 1 a steering gear assembly for a rack and pinion steering system, indicated generally at 10, mounted to a frame of a vehicle (not shown) by a first mounting bracket 11 and a second mounting bracket 13.

The steering gear assembly 10 includes a modular steering gear housing 12 that houses a portion of an input shaft 14. A first end of the input shaft 14 is coupled to a steering wheel (not shown) through conventional steering linkages (not shown) and receives rotational input from a driver of the vehicle. The input shaft 14 includes a pinion gear 16 formed on a second end of the input shaft 14.

The modular steering gear housing 12 further houses a rack 20. The rack 20 includes rack gear teeth 22 that mesh with the pinion gear 16 within the modular steering gear housing 12 for laterally displacing the rack 20 when the input shaft 14 is rotated. The opposite ends of the rack 20 each include a ball and socket joint (not shown) for coupling tie rods (not shown) to the rack 20. The tie rods are connected to steerable wheels (not shown) for steering the vehicle via the driver's manual input commands to the steering wheel.

A piston 24 is affixed about an outer diameter of the rack 20 within the modular steering gear housing 12. An inner rack seal 26 is disposed within the modular steering gear housing 12. The inner rack seal 26 is a free floating seal used to create a moveable seal between the rack 20 and the modular gear housing 12. A first chamber 28 is formed in cooperation with the inner wall of the rack tube 24, the inner rack seal 26, and piston 24. A first pressure port 30 is formed in the modular steering gear housing 12 at a region of the first fluid chamber 28. The first pressure port 30 is a bore extending through the wall of the modular steering gear housing 12.

A first fluid conduit 32 is secured to the first pressure port 30 for allowing hydraulic fluid flow to and from the first fluid chamber 28. A fitting formed with the first pressure port is preferably welded directly to the modular steering gear housing 12 at the first fluid chamber 28. Alternatively, other methods may be used to secure the hydraulic fluid line 32 to the first pressure port 30 such as a press-fit connection, adhesives, chemical bonding, a quick-fit connection, or a pressure fitting may be adapted to the modular steering gear housing 12.

An outer rack seal 34 is seated at an opposing end of the rack 20 for forming a second chamber 36 in cooperation with the rack 20 and piston 24. The outer rack seal 34 is preferably a single o-ring seal disposed between the inner wall of the modular steering gear housing 12 and the rack 20. Preferably the outer rack seal 34 is a Teflon ring. Alternatively, the outer rack seal 34 may be made from other material and may further include a double o-ring.

A second pressure port 38 is formed in the modular steering gear housing 12 at a region over the second fluid chamber 36. A second fluid conduit 40 is secured to the second pressure port 38 for allowing hydraulic fluid flow to and from the second fluid chamber 36. A fitting formed with the second pressure port 38 is preferably welded to the modular steering gear housing 12 at the second fluid chamber 36. Similarly to the first pressure port 30, other alternative methods as described above may be used to secure the hydraulic fluid line 40 to the first pressure port 38.

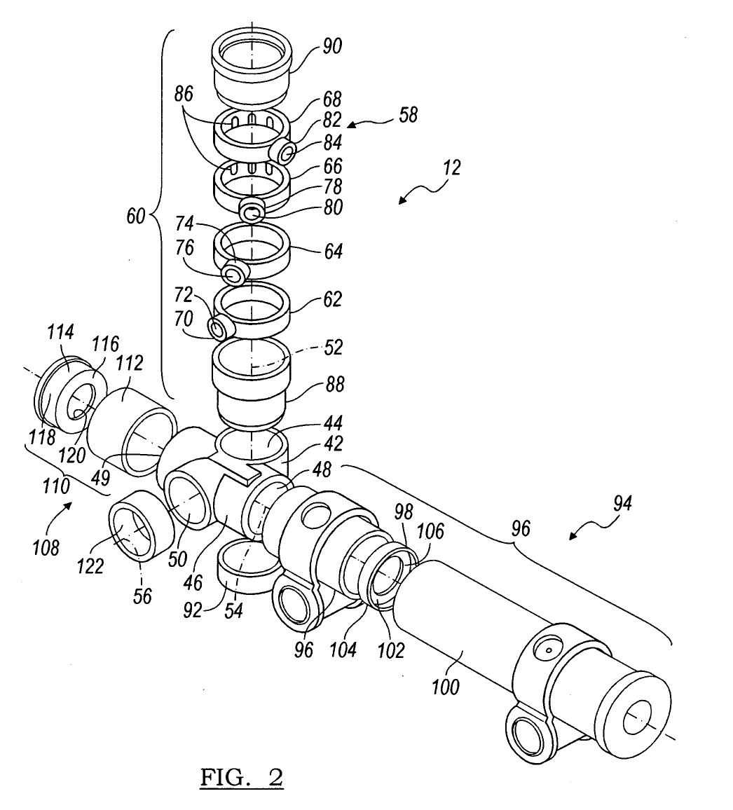

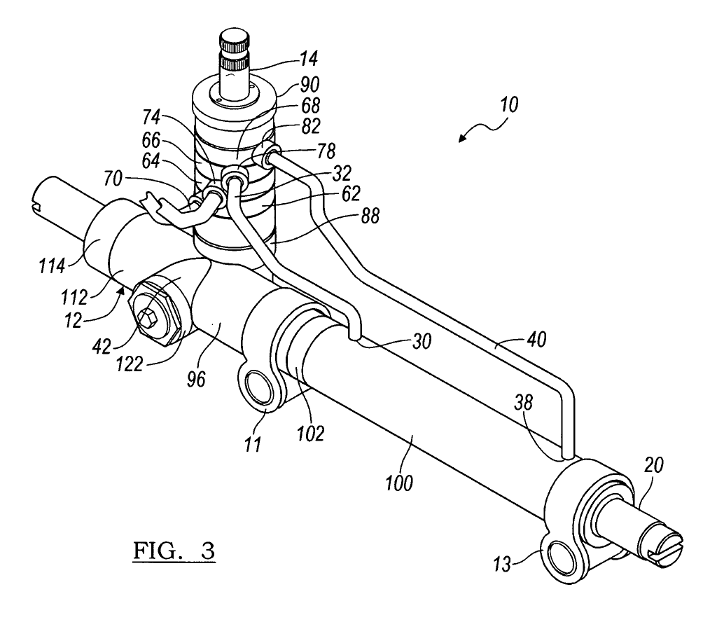

Referring to FIG. 2 and FIG. 3, the modular steering gear housing 12 includes a central housing member 42. The central housing member 42 includes a first port 44, a second port 46, a third port 48, a fourth port 49, and a fifth port 50, each providing access to the interior of the central housing member 42.

The first port 44 is aligned with a first axis 52. The second port 46 is preferably aligned with the first axis 52, but it may alternatively be off-centered from the first axis 52.

The third port 48 is aligned with a second axis 54. The fourth port 49 is preferably aligned with the second axis 54, but it may be off-centered from the second axis 54. The fifth port 50 is aligned with a third axis 56.

A tower housing member 58 includes a first plurality of mutually interconnected tubular sections 60 for housing a first portion of the input shaft 14. The first plurality of mutually interconnected tubular sections 60 include a first ring member 62, a second ring member 64, a third ring member 66, and a fourth ring member 68. The first ring member 62 includes a boss 70 having a bore 72 extending the boss 70 and a wall section of the first ring member 62. Preferably, each of the respective ring members are mutually identical since they are formed from the same forming process and are interchangeable with one another. As a result, the second ring member 64 includes a boss 74 having a bore 76, the third ring member 66 includes a boss 78 having a bore 80, and the fourth ring member includes a boss 82 having a bore 84.

Each of the respective ring members is aligned with the first axis 52 and circumferentially positioned such that each respective bore is aligned with a respective fluid conduit prior to the ring members being mutually interconnected. In addition, each of the respective ring members may include one or more alignment locators 86 such as a grooved section, a notched section, or similar locating member for aligning the respective ring members to one another.

The first plurality of mutually interconnected tubular sections 60 of the tower housing member 58 further includes a first end tubular section 88 and a second end tubular section 90. The first end tubular section 88 is interconnected to the first ring member 62. The first end tubular section 88 receives the input shaft 14 as it is assembled into the tower housing member 58. The second end tubular section 90 may be cup-shaped with an aperture to seal against the input shaft 14 or an additional cap member may be disposed over the second end tubular section 90 to seal against the input shaft 14.

The second end tubular section 90 is interconnected to fourth ring member 68. The first end tubular section 88 is also coupled to the first port 44 for securing the tower housing member 58 to the central yoke member 42.

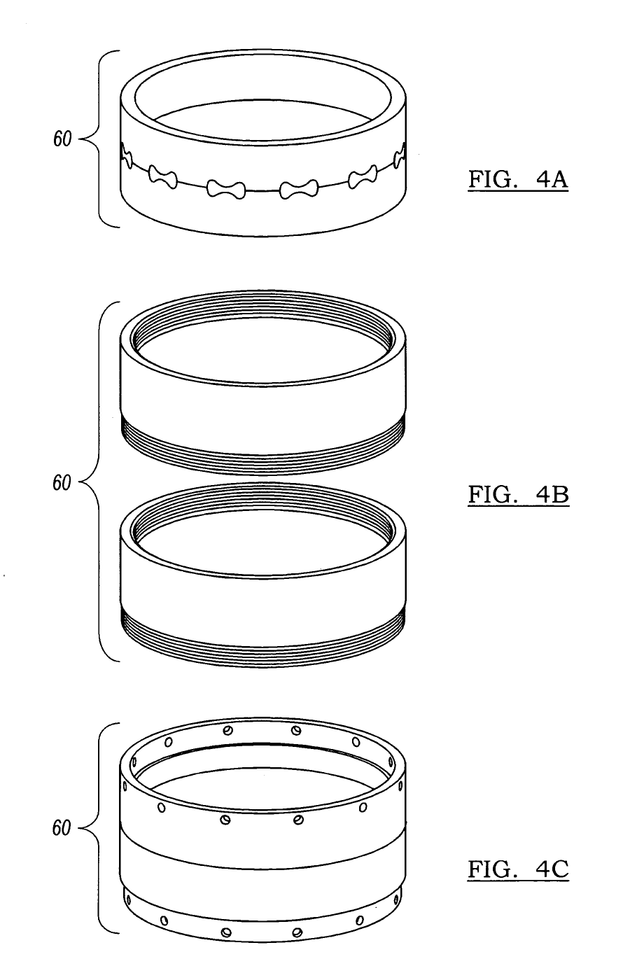

The first plurality of mutually interconnected tubular sections 60 including first end tubular section 88 and the second end tubular section 90 and central housing member 42 are interconnected by a fastening process such as threaded end portions (shown in FIG. 4a), adhesive, chemical bonding, or welding (shown generally in FIG. 4b), quick connect method or press-fit (shown in FIG. 4c) or other similar means.

A tower housing member end cap 92 includes at least one tubular section for housing a second portion of the input shaft 14. The tower housing member end cap 92 is coupled to the second port 46 for securing the tower end cap housing member 92 to the central yoke member 42. The tower end cap housing member 92 may be secured to the central yoke member 42 in a same or similar fastening process described above for the tower housing member 58. The tower end cap housing member 92 may be cup-shaped to enclose the bottom portion of the input shaft 14 within the modular steering gear housing 12 or an additional cap member may be disposed over an end of the tower end cap housing member 92.

A rack housing member 94 includes a second plurality of mutually interconnected tubular sections 96 for housing a first portion of the rack 20. The second plurality of mutually interconnected tubular sections 94 includes a first rack tubular member 96, a rack intermediate flange member 98, and a second rack tubular member 100 interconnected to one another by a same or similar fastening process discussed above for the tower housing member 58. The rack housing member 94 is aligned with the second axis 54 and the first rack tubular member 96 of the rack housing member 94 is coupled to the third port 48 for securing the rack housing member 94 to the central yoke member 42.

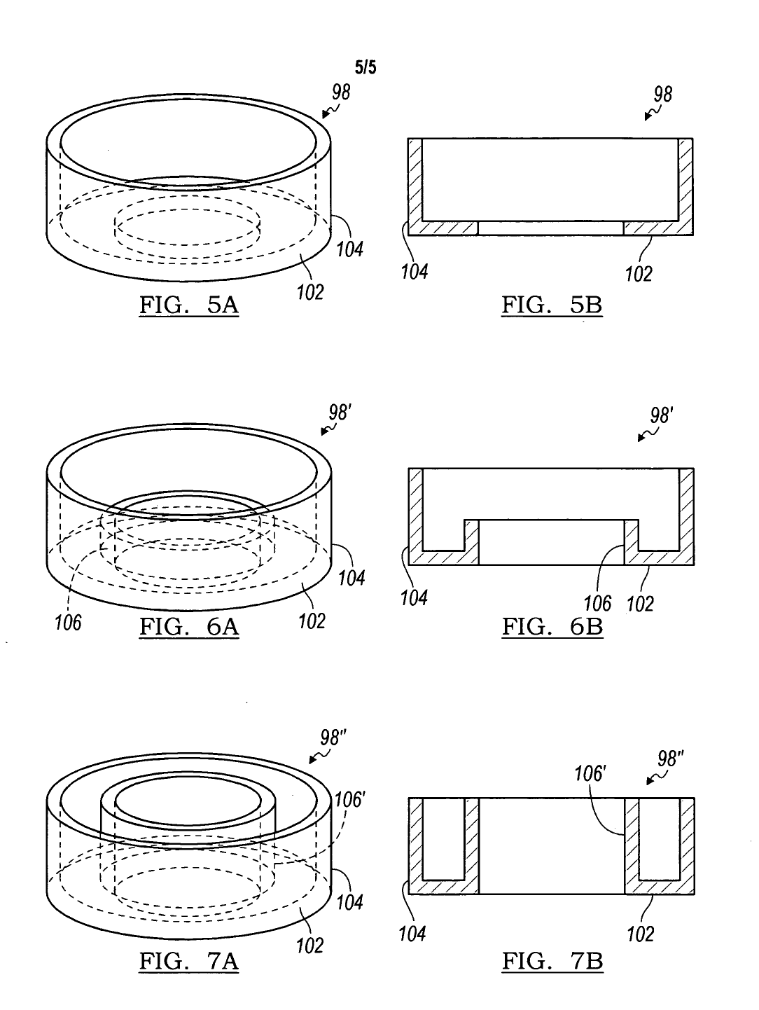

FIGS. 5a and 5b show an enlarged perspective view and a cross section view of the rack intermediate flange member 98, respectively. The rack intermediate flange member 98 includes a flange section 102, which extends radially inward from an outer tubular section 104 for functioning as a bushing for support of the rack 20 (shown in FIG. 1). The rack intermediate flange member 98 eliminates an additional component, specifically an insert bushing, typically used in conventional steering gear assemblies. In other embodiments, an inner tubular section 106 may extend from an end of the flange section 102, thereby forming a J-shaped section or U-shaped section for providing a substantial surface area for bushing support.

FIGS. 6a and 6b show the inner tubular section 106 integrally formed as part of the rack intermediate flange member 98. FIGS. 6a and 6b show a perspective view and a cross section view of the rack intermediate flange member 98′, respectively. The inner tubular section 106 extends from the flange section 102 and is substantially parallel to the outer tubular section 104. The inner tubular section 106 supports the rack 20 (shown in FIG. 1) as the rack 20 slides in and out of the rack intermediate flange member 98′. The length of the inner tubular section 106 is less than the length of the outer tubular section 104, thereby forming a J-shaped section.

FIG. 7a illustrates an inner tubular section 106′ integrally formed as part of the rack intermediate flange member 98″. FIG. 7b shows a cross section view of the inner tubular section 106′. The inner tubular section 106′ extends from the flange section 102 and is substantially parallel to the outer tubular section 104. The inner tubular section 106′ supports the rack 20 (shown in FIG. 1). The length of the inner tubular section 106′ is substantially equal to the length of the outer tubular section 104, thereby forming a U-shaped section.

A rack end cap housing member 108 includes a third plurality of mutually interconnected tubular sections 110 for housing a second portion of the rack 20. The third plurality of mutually interconnected tubular sections 110 includes a rack end cap tubular member 112 and a rack end intermediate flange member 114. Additional tubular sections may be added if necessary. The rack end cap tubular member 112, and rack end intermediate flange member 114 are interconnected to one another by a same or similar fastening process discussed above for the tower housing member 58. Preferably, the rack end cap housing member 108 is aligned with the second axis 54, but alternatively, it may be off-centered if required. The rack end cap tubular member 112 is coupled to the fourth port 49 for securing the rack end cap housing member 108 to the central yoke member 42.

The rack end intermediate flange member 114 includes a flange section 116, which extends radially from an outer tubular section 118 that functions as a bushing for supporting the rack 20. Similar to the rack intermediate flange member (shown in FIGS. 5-7), an inner tubular section 120 may extend from an end of the flange section 116, thereby forming a J-shaped section or U-shaped section for providing a substantial surface area for bushing support.

An end cap retention housing member 122 is axially aligned with the third axis 56. Preferably, the end cap retention housing member 122 is a single piece tubular member and cup-shaped with an aperture to form the receive a rack guide adjusting (shown in FIG. 1) or an additional cap member with an aperture may be disposed over the end cap retention housing member 122. Alternatively, more than one tubular section may used as part of the end cap retention housing member 122. The end cap retention housing member 122 is coupled to the fifth port 50 for securing the end cap retention housing member 122 to the central yoke member 42. The end cap retention housing member 122 may be secured using the same or similar fastening means as discussed above for the tower housing member 58.

Preferably, each of the tubular sections discussed above are mass produced using a forming operation such as cold forming. Alternatively, other methods may be used to produce each of the tubular sections.

In accordance with the provisions of the patent statutes, the principle and mode of operation have been explained and illustrated in preferred embodiments. However, it must be understood that this invention may be practiced otherwise than as specifically explained and illustrated without departing from its spirit or scope.

What is claimed is:

1. A steering gear housing assembly for housing a rack and a steering input shaft, said housing assembly comprising:
a central housing member;
a tower housing member including a first plurality of mutually interconnected tubular sections secured to the central housing member;
a tower end cap housing member including at least one tubular section coupled to said central housing member;
a rack housing member including a second plurality of interconnected tubular sections secured to said central housing member;
a rack end cap housing member including a third plurality of interconnected tubular sections and secured to said central housing member; and
an end cap retention housing member secured to said central housing member.

2. The housing assembly of claim 1 wherein said central housing member comprises:
a first port and a second port, at least one of said first and second ports being aligned with a first axis, said first port and said second port providing access to an interior of said central housing member;
a third port and a fourth port, at least one of said third and fourth port being aligned with a second axis, said third port and said fourth port providing access to said interior of said central housing member; and
a fifth port aligned with a third axis providing access to said interior of said central housing member.

3. The housing assembly of claim 2 wherein said tower housing member is secured to the central housing member at said first port, said tower end cap housing member is secured to said central housing member at said second port, said rack housing member is secured to said central housing member at said third port, said rack end cap housing member is secured to said central housing member at said fourth port, and said end cap retention housing member secured to said central housing member at said fifth port.

4. The housing assembly of claim 1 wherein said first plurality of tubular sections includes a first ring member, a second ring member, a third ring member, and a fourth ring member, each of said ring members having a respective bore through a respective wall section for transferring fluid to and from an interior of said tower housing member.

5. The housing assembly of claim 4 wherein each of said ring members prior to being interconnected, are rotatable about said first axis for angularly positioning each of said respective bores into alignment with a respective fluid transfer conduit.

6. The housing assembly of claim 5 wherein each of said ring members includes locating grooves for orienting said ring members.

7. The housing assembly of claim 1 wherein a respective tubular section of said rack end housing member includes a flange portion for providing a bushing support for said rack.

8. The housing assembly of claim 1 wherein each of said tubular sections includes threaded portions for interconnecting each of said tubular sections.

9. The housing assembly of claim 1 wherein each of said tubular sections includes quick connect mechanisms for interconnecting each of said tubular sections.

10. The housing assembly of claim 1 wherein each of said tubular sections are interconnected by a welding process.

11. The housing assembly of claim 1 wherein each of said tubular sections are interconnected by a chemical bonding process.

12. The housing assembly of claim 1 wherein each of said tubular sections are interconnected by an adhesion bonding process.

13. The housing assembly of claim 1 further comprising at least one mounting bracket is disposed about an outer surface of a respective tubular section for mounting to a vehicle member.

14. A steering gear assembly comprising:
an input shaft having a gear formed on said input shaft;
a rack tube having teeth for meshing with said gear of said input shaft;
a modular housing comprising:
a central housing member having an interior housing portion for housing an interconnection between said gear of said input shaft and said teeth of said rack tube, said central housing member comprising:
a first port and a second port, at least one of said first and second ports aligned with a first axis for providing access to said interior of said central housing member;
a third port and a fourth port, at least one of said third and fourth ports aligned with a second axis for providing access to said interior of said central housing member; and
a fifth port aligned with a third axis for providing access to said interior of said central housing member;
a tower housing member axially aligned with said first axis for housing a first portion said input shaft, said tower housing member including a first plurality of interconnected tubular sections secured to said central housing member at said first port;
a tower end cap housing member axially aligned with said first axis including at least one tubular section secured to said central housing member at said second port;
a rack housing member axially aligned with said second axis and including a second plurality of interconnected tubular sections secured to said central housing member at said third port;
a rack end cap housing member axially aligned with said second axis including a third plurality of interconnected tubular sections and secured to said central housing member at said fourth port; and
an end cap retention housing member axially aligned with said third axis and including at least one tubular section secured to said central housing member at said fifth port;
a first rack seal and a second rack seal disposed within said rack housing member, said first rack seal being in spaced relation to said second rack seal;
a piston coupled to said rack and spaced between said first rack seal and said second rack seal;
a first fluid chamber formed within said rack housing member between said first rack seal and said piston;
a second fluid chamber formed within said rack housing member between said second rack seal and said piston;
a first fluid conduit coupled to a first respective tubular section of said tower housing member for transferring fluid between said first tower housing member and said first fluid chamber; and
a second fluid conduit coupled to said first respective tubular section of said tower housing member for transferring fluid between said first tower housing member and said second fluid chamber.

15. The housing assembly of claim 14 wherein said first plurality of tubular sections includes a first ring member, a second ring member, a third ring member, and a fourth ring member, each of said ring members having a respective bore through a respective wall section for transferring fluid to and from an interior of said tubular housing.

16. The housing assembly of claim 15 wherein each of said ring members are rotatable about said first axis prior to being interconnected for circumferentially positioning each of said respective bores to be adapted to be coupled to respective fluid conduits.

17. A method for assembling modular steering gear housing comprising the steps of:
providing a central housing member having a first port, a second port, a third port, a fourth port, and a fifth port;
aligning a first plurality of tubular sections with said first port of said central housing member, said first plurality of tubular sections including a plurality of ring members, said plurality of ring members each having a respective bore through a respective wall section;
orienting said plurality of ring members circumferentially so that a respective bore of each said ring member is aligned for coupling to a respective fluid conduit;
interconnecting a first plurality of tubular sections for forming a tower housing member, said tower housing member being secured to said first port of said central housing member;
securing a tower end cap to said second port of said central housing member, said tower end cap including at least one tubular section;
interconnecting a second plurality of tubular sections to form a rack housing member, said rack housing member being secured to said third port of said central housing member;
interconnecting said third plurality of tubular sections to form a rack end housing member, said rack end housing member being secured to said fourth port of said central housing member; and
securing an end cap retention housing member to said fifth port of said central housing member.

18. The method of claim 15 wherein each of said tubular sections of said tower housing member, said tower end cap, said rack housing, said rack end housing member, and said end cap retention housing member are interconnected by a fastening operation.

19. The method of claim 15 wherein said fastening operation includes a welding operation.

20. The method of claim 15 wherein said fastening operation includes a chemical bonding operation.

21. The method of claim 15 wherein said fastening operation includes an adhesive bonding operation.

22. The method of claim 15 wherein said fastening operation includes mating threaded portions.

23. The method of claim 15 wherein said fastening operation including coupling by a quick connect mechanism.

24. The method of claim 15 wherein each of said ring members are aligned by alignment notches formed in each of said ring members.
